(19) United States
(12) Patent Application Publication
(10) Pub. No.: US 2012/0124803 A1
(43) Pub. Date: May 24, 2012

(54) GYMNASTIC AUXILIARY APPARATUS FABRICATION METHOD

(76) Inventor: Victor TSAI, Taipei (TW)

(21) Appl. No.: 13/011,719

(22) Filed: Jan. 21, 2011

(30) Foreign Application Priority Data
Nov. 23, 2010 (TW) 99140415

(51) Int. Cl. B23P 17/04

(52) U.S. Cl. 29/428

(57) ABSTRACT

An environmentally friendly and adhesive-free gymnastic auxiliary apparatus fabrication method includes the step of preparing a soft covering layer and arranging it into a tube having a tubular accommodation space defined therein, the step of inserting a tubular first foam material into the tubular accommodation space of the tubular soft covering layer, and the step of inserting an elastic solid cylindrical second foam material into the axial center hole of the tubular first foam material to expand the tubular first foam material for enabling the tubular first foam material to be compacted in between the solid cylindrical second foam material and the soft covering layer subject to the effect of the tension of the tubular soft covering layer and the elasticity of the second foam material.

### BACKGROUND OF THE INVENTION

1. Field of the Invention

The present invention relates to the fabrication of a gymnastic auxiliary apparatus and more particularly, to an environmentally friendly gymnastic auxiliary apparatus fabrication method, which eliminates the use of an adhesive to bond component parts.

2. Description of the Related Art

When performing Yoga, Pilates or gymnastic exercises, an auxiliary apparatus, such as rhythmic ball or gymnastic bar may be used to assist the performance. A rhythmic ball is a soft ball filled with a gas. A gymnastic bar is normally made of an EVA (ethylene vinyl acetate) copolymer or PU (polyurethane) foam material.

FIG. 1 illustrates a gymnastic bar 10 made according to Taiwan Utility Model M369777. According to this design, the gymnastic bar 10 includes a core member 11 made of a soft foam material, a wrapping layer 12 surround the core member 11 and a covering layer 13 surrounds the wrapping layer 12. The core member 11 defines therein an axial through hole 14. Subject to the design of the axial through hole 14, the gymnastic bar 10 can be elastically deformed when pressed by a human body, enhancing applicability. However, the design of the axial through hole 14 lowers the supportability of the gymnastic bar 10 and reduces the feedback force of the gymnastic bar 10 to the user. Thus, using this design of gymnastic bar 10 tends to cause an athletic injury and cannot effectively assist user's performance. Further, in FIG. 1 of the specification of Taiwan Utility Model M369777, a solid gymnastic bar is illustrated. However, the specification does not disclosure its fabrication method. Further, the covering layer of a solid gymnastic bar is adhered the wrapping layer with an adhesive. As the adhesive deteriorates with the use of the gymnastic bar, the covering layer may drop or forced apart from the wrapping layer after a long use of the gymnastic bar.

### SUMMARY OF THE INVENTION

The present invention has been accomplished under the circumstances in view. It is the main object of the present invention to provide a gymnastic auxiliary apparatus fabrication method, which enables a soft covering layer, a tubular first foam material and a second foam material to be fastened together to form the desired gymnastic auxiliary apparatus without any adhesive, enhancing the environmentally friendly characteristic and avoiding separation between the foam materials and the soft covering layer due to the adhesive deterioration after a long use.

To achieve this and other object of the present invention, a gymnastic auxiliary apparatus fabrication method includes the steps of:

a) preparing a soft covering layer and arranging the soft covering layer into a tube having a tubular accommodation space defined therein;

b) inserting a tubular first foam material into said tubular accommodation space of said tubular soft covering layer, said tubular first foam material defining therein an axial center hole; and

c) inserting an elastic solid cylindrical second foam material into the axial center hole of said tubular first foam material to expand said tubular first foam material, enabling said tubular first foam material to be compacted in between said solid cylindrical second foam material and said soft covering layer subject to the effect of the tension of said tubular soft covering layer and the elasticity of said second foam material.

As the invention eliminates the use any adhesive to bond the soft covering layer, the tubular first foam material and the second foam material together, enhancing the environmentally friendly characteristic and avoiding separation between the foam materials and the soft covering layer due to deterioration of the adhesive after a long use.

Further, the soft covering material prepared during step (a) can be a cotton, nylon, tetoron fabric or PU (polyurethane) sheet material. In this case, the soft covering material prepared during step (a) is arranged into a tube by means of stitching two opposing side edges of the fabric together.

Further, the soft covering material prepared during step (a) can be a plastic sheet material, for example, PE, PP or PVC. In this case, the soft covering material prepared during step (a) is arranged into a tube by means of employing a high-frequency heat sealing technique to seal two opposing side edges of the plastic sheet material together.

Further, the tubular first foam material is selected from the material group of PE (polyethylene), PP (polypropylene), PS (polystyrene), PU (polyurethane), PVC (polyvinyl chloride) and EVA (ethylene vinyl acetate) copolymer.

Further, the elastic solid cylindrical second foam material is selected from the material group of PE (polyethylene), PP (polypropylene), PS (polystyrene), PU (polyurethane), PVC (polyvinyl chloride) and EVA (ethylene vinyl acetate) copolymer.

Further, the tubular first foam material and the elastic solid cylindrical second foam material can be the same material.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is a schematic cross-sectional view of a gymnastic bar made of a foam material according to the prior art.

FIG. 2 is a schematic cross-sectional view of the present invention before insertion of a second foam material into the axial center hole of the first foam material, wherein the diameter of the second foam material is slightly greater than the axial center hole of the first foam material.

FIG. 3A is a schematic cross-sectional view of the soft covering layer prepared according to the present invention, illustrating a tubular accommodation space defined in the soft covering layer,

FIG. 3B is a schematic cross-sectional view of the present invention, illustrating the first foam material inserted into the tubular accommodation space of the soft covering layer.

FIG. 3C is a schematic cross-sectional view of the present invention, illustrating the second foam material inserted into the axial center hole of the first foam material.

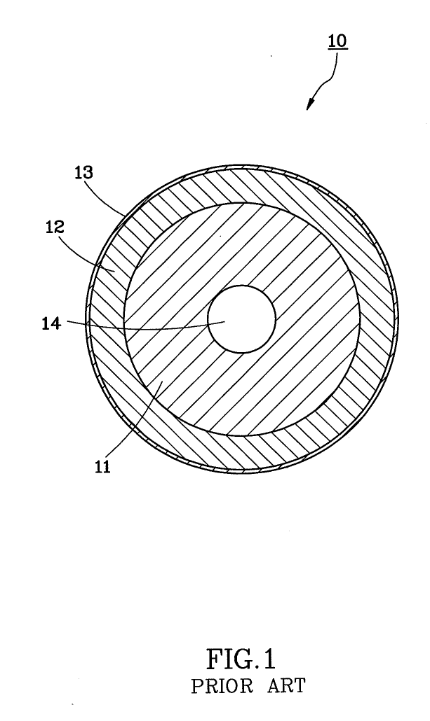

### DETAILED DESCRIPTION OF THE INVENTION

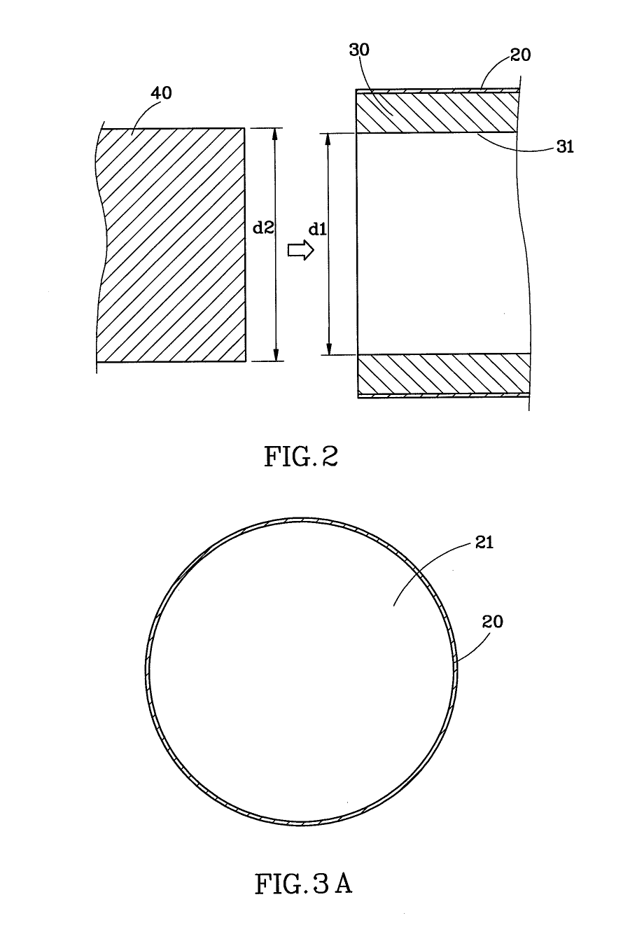

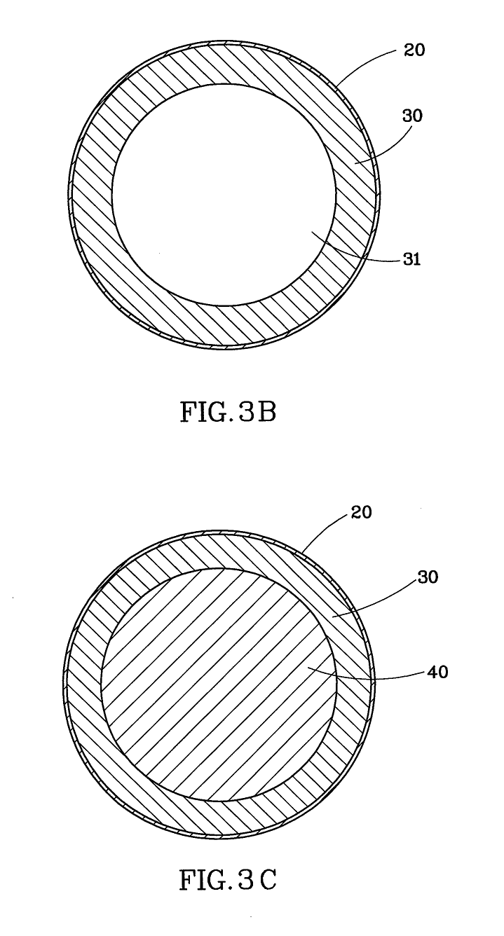

Referring to FIG. 2 and FIGS. 3A-3C, the invention provides a method for making a gymnastic auxiliary apparatus. The method includes the steps as follows:

At first, according to the present preferred embodiment, as shown in FIG. 3A, a soft covering layer 20 is prepared and arranged into a tube. For example, prepare a PVC (polyvinyl chloride) sheet material, and then fuse two opposing side edges of the PVC (polyvinyl chloride) sheet material together by means of a high-frequency heat sealing technique, thereby forming a tubular soft covering layer 20 that defines therein a tubular accommodation space 21. It is to be understood that PVC is simply an example of the invention. PE (polyethylene) or PP (polypropylene) plastic sheet material, or cotton, nylon or tetoron fabric, or PU (polyurethane) may be selectively used as a substitute. When a cotton, nylon, tetoron fabric or PU (polyurethane) sheet material is used, fasten two opposing side edges of the sheet material together with stitches, thereby forming the desired tubular soft covering layer 20.

Thereafter, as shown in FIG. 3B, insert a tubular first foam material 30 into the tubular accommodation space 21 of the tubular soft covering layer 20. The tubular first foam material 30 defines therein an axial center hole 31. The tubular first foam material 30 is selected from the material group of PE (polyethylene), PP (polypropylene), PS (polystyrene), PU (polyurethane), PVC (polyvinyl chloride) and EVA (ethylene vinyl acetate) copolymer.

At final, as shown in FIG. 2 and FIG. 3C, insert a solid cylindrical second foam material 40 into the axial center hole 31 of the tubular first foam material 30. The diameter d2 of the second foam material 40 is slightly greater than the diameter d1 of the axial center hole 31 of the tubular first foam material 30. Thus, when the second foam material 40 is inserted into the axial center hole 31 of the tubular first foam material 30, the second foam material 40 imparts a pressure to the tubular first foam material 30 radially against the soft covering layer 20, thereby compacting the thickness of the tubular first foam material 30 (see FIG. 3C). Subject to the tension of the tubular soft covering layer 20 and the elasticity of the second foam material 40, the tubular first foam material 30 and the second foam material 40 are firmly secured in place inside the tubular accommodation space 21 of the tubular soft covering layer 20 to provide better support and feedback force to the user. Further, the second foam material 40 can be selected from the material group of PE (polyethylene), PP (polypropylene), PS (polystyrene), PU (polyurethane), PVC (polyvinyl chloride) and EVA (ethylene vinyl acetate) copolymer.

Further, the gymnastic auxiliary apparatus fabrication method of the invention further includes a step of printing guidelines for the use of the gymnastic auxiliary apparatus on the surface of the soft covering layer, saving brochure printing cost and enhancing the environmentally friendly characteristic.

As stated above, a gymnastic auxiliary apparatus made according to the present invention r support and feedback force to the user, avoiding athletic injury and effectively assisting the user's performance. Further, the invention eliminates the use of any adhesive to bond the soft covering layer, the tubular first foam material and the second foam material together, enhancing the environmentally friendly characteristic and avoiding separation between the foam materials and the soft covering layer due to adhesive deterioration after a long use. Further, the method of the invention eliminates the necessity of printing brochures, enhancing the environmentally friendly characteristic

What is claimed is:

1. A gymnastic auxiliary apparatus fabrication method, comprising the steps of:
a) preparing a soft covering layer and arranging the soft covering layer into a tube having a tubular accommodation space defined therein;
b) inserting a tubular first foam material into said tubular accommodation space of said tubular soft covering layer, said tubular first foam material defining therein an axial center hole; and
c) inserting an elastic solid cylindrical second foam material into the axial center hole of said tubular first foam material to expand said tubular first foam material, enabling said tubular first foam material to be compacted in between said solid cylindrical second foam material and said soft covering layer subject to the effect of the tension of said tubular soft covering layer and the elasticity of said second foam material.

2. The gymnastic auxiliary apparatus fabrication method as claimed in claim 1, wherein said soft covering material prepared during step (a) is a fabric.

3. The gymnastic auxiliary apparatus fabrication method as claimed in claim 2, wherein said soft covering material prepared during step (a) is arranged into a tube by means of stitching two opposing side edges of the fabric together.

4. The gymnastic auxiliary apparatus fabrication method as claimed in claim 1, wherein said soft covering material prepared during step (a) is a plastic sheet material.

5. The gymnastic auxiliary apparatus fabrication method as claimed in claim 4, wherein said soft covering material prepared during step (a) is arranged into a tube by means of employing a high-frequency heat sealing technique to seal two opposing side edges of the plastic sheet material together.

6. The gymnastic auxiliary apparatus fabrication method as claimed in claim 1, wherein said tubular first foam material is selected from the material group of PE (polyethylene), PP (polypropylene), PS (polystyrene), PU (polyurethane), PVC (polyvinyl chloride) and EVA (ethylene vinyl acetate) copolymer.

7. The gymnastic auxiliary apparatus fabrication method as claimed in claim 1, wherein said elastic solid cylindrical second foam material is selected from the material group of PE (polyethylene), PP (polypropylene), PS (polystyrene), PU (polyurethane), PVC (polyvinyl chloride) and EVA (ethylene vinyl acetate) copolymer.

8. The gymnastic auxiliary apparatus fabrication method as claimed in claim 1, wherein said tubular first foam material and said elastic solid cylindrical second foam material are the same material.
